(19) United States
(12) Patent Application Publication
(10) Pub. No.: US 2025/0368017 A1
(43) Pub. Date: Dec. 4, 2025

(54) GLAZING UNIT COMPRISING IN A CORNER A PROFILED SEAL WITH CUTOUTS AND SLOT(S), SEAL AND METHOD OF MANUFACTURING SUCH GLAZING UNIT

(71) Applicant: SAINT-GOBAIN GLASS FRANCE, COURBEVOIE (FR)

(72) Inventor: Laurent SILVESTRINI, BUSSY (FR)

(21) Appl. No.: 18/874,425

(22) PCT Filed: Jun. 7, 2023
(86) PCT No.: PCT/EP2023/065205

§ 371 Date: Dec. 12, 2024

(30) Foreign Application Priority Data
Jun. 13, 2022 (FR) FR2205688

(51) Int. Cl. B60J 10/21; B60J 10/22; B60J 10/70

(52) U.S. Cl. CPC B60J 10/21; B60J 10/22; B60J 10/70

(57) ABSTRACT

A glazing unit includes a glazed element and a profiled seal, the profiled seal having a rounded corner a number x≥2 of transverse, recessed, material-removing cutouts and has a number y of curved slot(s) passing through the thickness of a base and located closer to the edge of said glazed element than the cutouts.

The invention relates to the field of glazing units, especially for vehicles, and in particular for motor vehicles. The invention relates more precisely to a glazing unit comprising a glazed element having an outer face, an inner face and an edge face located between these two faces, a longitudinal edge, a lateral edge and a rounded corner having at least one radius of curvature and being located between said longitudinal edge and said lateral edge.

The invention also relates to a particular profiled seal for such a glazing and to a method for manufacturing such a glazing.

It is known from the prior art, for example from International Patent Application No. WO 00/10793, that glazing units of the aforementioned type additionally comprise along one or more edges a profiled seal having a base and a lateral bead (or lateral lip), said base being attached to said inner face and said bead extending from said base further than said edge, in a centrifugal direction.

As it is difficult to produce such a profiled seal with a base and lateral bead (or lip) in the environment of a rounded corner, this document proposes to produce a specific rework using a mobile tool (mold/counter-mold).

This solution is technically satisfactory for a profiled seal produced by extrusion in situ against one face of the glazed element, but generates additional costs as the seal must be reworked in each corner, and extends the time the glazing remains in the station where the profiled seal is attached to the glazed element.

This solution is very difficult to apply to a prefabricated profile seal, manufactured prior to attachment to the glazed element.

The aim of the invention is to overcome the disadvantages of the prior art by offering a glazing unit with a profiled seal that adapts well and easily to the curvature of the corner, for easier and less expensive installation.

The present invention is thus based on the discovery that, surprisingly, it is possible to provide a profiled seal with a base attached to the glazed element and a lateral bead (or lip) in the environment of a corner, and in particular when the profiled seal is a prefabricated seal (technology known as “pre-assembly” in the glass industry).

The present invention thus relates, in its broadest sense, to a glazing unit according to claim 1. This glazing unit comprises a glazed element and a profiled seal, said glazed element having an outer face, an inner face and an edge face located between these two faces, a longitudinal edge, a lateral edge and a rounded corner having at least one radius of curvature and being located between said longitudinal edge and said lateral edge, said profiled seal having a base and a lateral bead, said base being attached to said inner face and said bead extending from said base further than said base, said glazing unit being remarkable in that in the environment of said corner, said base has a number x≥2 of transverse, recessed, material-removing cutouts and has a number y of curved slot(s) traversing the thickness of said base and located closer to the edge of said glazed element than said cutouts.

Said side edge can be oriented substantially perpendicular to said longitudinal edge.

Said profiled seal may consist of said base and said lateral bead.

Said base preferably extends to the longitudinal or lateral edge of the glazed element.

Said bead extends from said edge of the glazed element further than said edge in the centrifugal direction.

In the case of cutouts, the material is completely removed, resulting in the complete absence of profiled seal material at the point of the cutout; in the case of the preferred slot(s), preferably no material is removed, but only an incision is made through the entire thickness of the base (in the outward-inward direction).

The said profiled seal is attached to the said glazed element preferably only by virtue of the fact that only the said base is attached to the said inner face and only to the said inner face.

Thus, in the corner environment, the cutouts allow the base to be deformed to suit the curvature of the glazed element, and the slot(s) reduce internal stresses in the plastic material of said profiled seal. In this way, the bead retains a regular appearance (a regular profile), without blistering or distortion, in the corner environment.

Preferably, neither the cutouts nor the slot(s) extend into said bead.

Preferably, for the profiled seal to deform better in the environment of said corner, x is an even number and y=x/2+1, or y=x/2−1, with preferably 4≤x≤10.

Preferably, so that the profiled seal deforms better in the environment of said corner, at least one, and preferably each, cutout has a transverse plane of symmetry and is preferably, seen from the front, V-shaped, or U-shaped, or Y-shaped, particularly V-shaped with an angle between two wings of the V of between 45° and 90°, preferably with an angle of around 60°.

Preferably, the said radius of curvature, or each radius of curvature, is between 50 mm and 230 mm.

Preferably, at least one, and preferably each, cutout has a width of between 50% and 80% of the width of said base.

Preferably, said slots are located in a boss of said base. Preferably, said cutouts are not located in this boss.

Preferably, at least one, and more preferably each, cutout has a length and said cutouts are positioned in pairs, with a distance between two cutouts of a pair of between 100% and 300% of said length and with a distance between two cutouts of two successive pairs which is greater than said distance between two cutouts of a pair and which is between 200% and 500% of said length.

Preferably, at least one, and even more preferably each, cutout has a length of between 50% and 100% of the width of said base.

Preferably, said slot(s) is (are) located in a portion of said profiled seal which is located between two pairs of cutouts and said slot(s) has (have) a length of between 75% and 100% of said distance between two pairs. Preferably, said slot(s) is (are) located centered between two pairs of cutouts.

Preferably, said bead is in surface continuity with said outer surface of the glazed element.

The concept of surface continuity within the meaning of the present invention, or “flush”, means that visually, from the outside space, the two surfaces appear in continuity with each other. In practice, it is possible to measure a height difference of up to 1 mm due to manufacturing tolerances.

Advantageously, the said profiled seal extends from the edge of the glazed element, being in surface continuity with the outer face of the glazed element along the entire length of the profiled seal, both in the longitudinal portion or portions and in the lateral portion or portions and in the corner or corners.

Advantageously, the said profiled seal extends from the edge of the glazed element, being in surface continuity with the outer face of the glazed element along the entire periphery of the glazed element.

Another object of the invention is a profiled seal for the glazing unit according to the invention, said profiled seal having a base and a lateral bead, said base being intended to be attached to said inner face of the glazed element of the glazing and said bead extending from said base further than said base, said profiled seal being remarkable in that said base has a number x≥2 of transverse, recessed, material-removing cutouts and has a number y of slot(s) passing through the thickness of said base and intended to be located closer to the edge of said glazed element than said cutouts. Said slot(s) is (are) closer to said lateral bead than said cutouts. Said slot(s) is (are) adapted, that is, intended, to be curved in the environment of a corner of said glazed element

Preferably, said profiled seal is based on a polymer material such as a thermoplastic (PVC, TPE, etc.), a polyurethane or a synthetic rubber of the EPDM type. The profiled seal can be made entirely of polymeric material or partially of polymeric material with a reinforcing insert, e.g., of metallic material. Said base may comprise an insert.

Preferably, the said profiled seal has two zones, each with x cutouts and y slot(s), for two corners of the glazing unit, in particular two lower corners of the glazing unit, or four zones, each with x cutouts and y slot(s), for four corners of the glazing unit.

Preferably, for a corner and in particular for a corner with a plane of symmetry, the cutouts are identical (same shape, same dimensions) and if there are several slots, they are identical (same shape, same dimensions). Preferably, for a corner with a plane of symmetry, the area comprising x cutouts and y slot(s) has a plane of symmetry that coincides with the plane of symmetry of said corner.

The invention also relates to a method for manufacturing a glazing unit according to the invention, said glazing unit comprising a glazed element and a profiled seal, said glazed element having an outer face, an inner face and an edge face located between these two faces, a longitudinal edge, a lateral edge and a rounded corner, having at least one radius of curvature and being located between said longitudinal edge and said lateral edge, said profiled seal having a base and a lateral bead, said base being attached to said inner face and said bead extending from said base further than said base, said method being remarkable in that
a number x≥2, of transverse, recessed cutouts are made in said base with removal of material and a number y of slot(s) is (are) made in said base through the thickness of said base, then
said profiled seal is attached to said glazed element with the cutouts and slot(s) located in the environment of said corner, with said slot(s) located closer to the edge of said glazed element than said cutouts and with said slot(s) curved in the environment of said corner.

Described below, by way of non-limiting examples, will be several embodiments of the present invention referring to the appended figures in which:

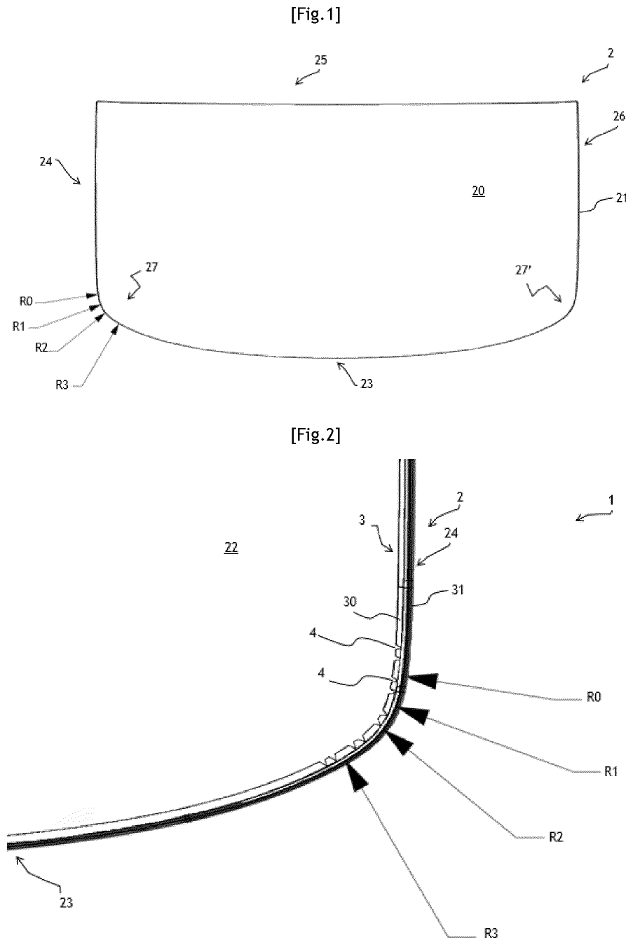

FIG. 1 shows a front view of the exterior space of a glazed element;

FIG. 2 shows a view of the lower right-hand corner of a glazing unit according to the invention, comprising the glazed element of FIG. 1 and a profiled seal, as seen from the interior space;

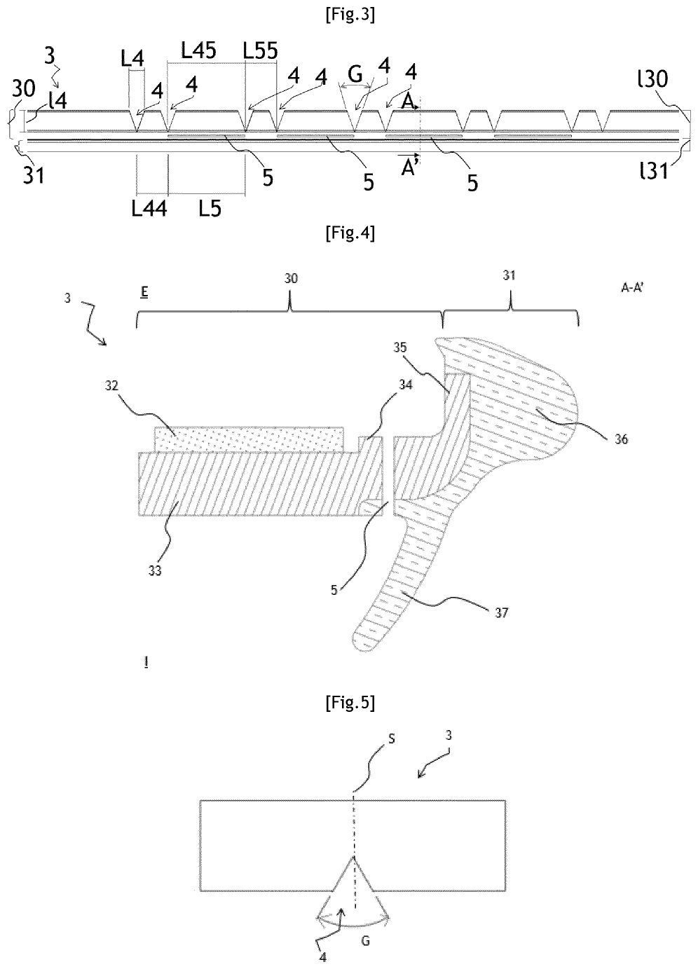

FIG. 3 shows a partial view of the profiled seal of FIG. 2, before it is curved to match the curvature of a corner of the glazed element, before it is attached to the glazed element;

FIG. 4 shows a cross-sectional view along A-A′ of the profiled seal of FIG. 3, before it is curved to match the curvature of a corner of the glazed element, before it is attached to the glazed element;

FIG. 5 shows a partial front view of a V-shaped cross-section of the profiled seal;

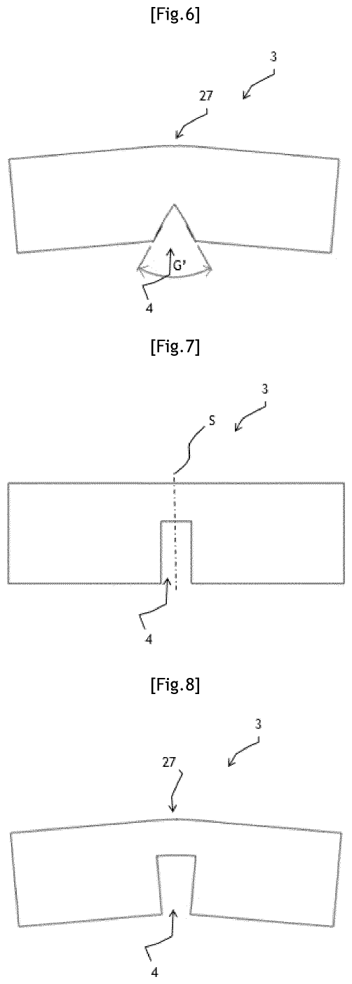

FIG. 6 shows a partial view of the cutout in FIG. 5 in the corner environment;

FIG. 7 shows a partial front view of a rectangular cross-section of the profiled seal;

FIG. 8 shows a partial view of the cutout in FIG. 7 in the corner environment;

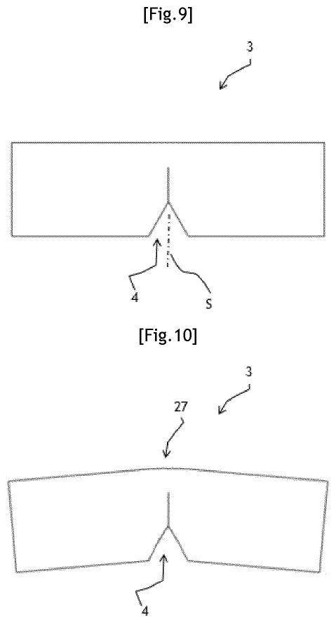

FIG. 9 shows a partial front view of a Y-shaped cross-section of the profiled seal; and

FIG. 10 shows a partial view of the cutout in FIG. 9 in the corner environment.

The present invention is described by way of example in the context of an application as glazed unit 1, fixed, for a vehicle. This glazed unit closes an opening by providing the separation between an exterior space E which is outside the vehicle, and an interior space I which is inside the vehicle. The ideas of “exterior” and “interior” are therefore considered relative respectively to the exterior space and the interior space.

The present invention is described, by way of non-limiting example, by being applied to a rear window glazed unit of a vehicle. Referring to FIG. 1, the glazing unit is viewed from the outside, oriented vertically as in a vehicle. In FIG. 2, the glazing unit is shown schematically, in a view equivalent to a view from the interior space, with the glazing unit not yet installed in a body opening (it is therefore not visible).

The glazing unit 1 comprises a glazed assembly 2. This glazed element may be monolithic, that is, made up of a single sheet of material, or may be composite, that is, made up of several sheets of material between which at least one interlayer of adhesive material is inserted in the case of laminated glazing units. The sheet(s) of material may be made of mineral material, in particular glass, having for example undergone annealing or tempering, or of organic material, particularly of plastic material such as polyvinyl butyral. The interlayer preferably contains at least one thermoplastic plastic material, preferably polyvinyl butyral (PVB), ethylene-vinyl acetate (EVA), and/or polyethylene terephthalate (PET). However, the thermoplastic interlayer may also contain, for example, polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylene, polyvinyl fluoride and/or ethylene-tetrafluoroethylene, or copolymers or mixtures thereof. The thermoplastic interlayer may be formed from one or more superimposed thermoplastic films, the thickness of a thermoplastic film not exceeding, preferably, 1.0 mm, in particular 0.25 mm or 0.5 mm to 1.0 mm or 0.9 mm, typically around 0.4 mm or 0.7 mm.

The glazing unit can form a windshield, roof, side or rear window for a vehicle. The vehicle can be a road vehicle, such as a car, truck, bus, streetcar or rail vehicle. The glazing may be fixed (non-movable in the vehicle's frame of reference).

In the context of the present document, the idea of “centripetal” and that of “centrifugal” is to be considered with respect to the central longitudinal axis of forward travel of the vehicle equipped with the glazing unit according to the invention used as a windshield, that is, the axis generally referred to as the “X-X′axis” of the vehicle, which is perpendicular to the plane of the sheet in FIG. 1; the centrifugal direction is perpendicular to this axis and in the direction of this axis whereas the centripetal direction is perpendicular to this axis and in the opposite direction, extending away from this axis.

In the exemplary embodiment shown, the glazing unit 1 includes a glazed element 2 that is curved (that is, not flat) and laminated.

The glazed element 2 has an outer face 20 oriented toward the exterior space E, an internal face 22 oriented toward the interior space I, and an edge face 21 situated between these two faces.

The glazed element 2 has a low longitudinal edge 23, a left lateral edge 24, a high longitudinal edge 25 and a right lateral edge 26.

The glazed element 2 has two lower corners 27, 27′, located:
for the corner 27, between the bottom longitudinal edge 23 and the side edge 24, and visible in FIG. 2, from the interior space I,
and for the corner 27′, between the lower longitudinal edge 23 and the side edge 26.

The glazing unit 1 includes a profiled seal 3, detailed below.

The glazed element 2 is a laminated glazed element comprising an exterior glass sheet, an interior glass sheet and a plastic interlayer sheet that is located between said two glass sheets.

However, it is possible for at least one other sheet to be interposed between the exterior glass sheet and the plastic interlayer sheet, or between the plastic interlayer sheet 4 and the inner glass sheet.

The glazed element 2 thus has an outer face 20 produced by an outer face of the exterior glass sheet, an interior face 22 produced by an interior face of the interior glass sheet and an edge face 21 situated between these two faces, corresponding to the edge face of the exterior glass sheet, to the edge face of the plastic sheet and to the edge face of the interior glass sheet, these three edge faces here being in line with one another.

In addition to the glazed element 2, the glazing unit 1 comprises a profiled seal 3 along at least part of the lower longitudinal edge, and preferably along the entire lower longitudinal edge, as shown in detail in FIG. 2 to FIG. 4.

The profiled seal 3 is made up of two distinct parts: a base 30 and a lateral bead 31. The base 30 is a part of the profiled seal 3 which is attached to the inner face 22, extending to the longitudinal or lateral edge of the glazed element. The bead 31 is a part of the profiled seal 3 that is not attached to the glazed element and extends from the base (that is, from the edge 21 when installed in the glazing unit) further than the base 30 (that is, further than the edge face 21 when installed in the glazing unit) in the centrifugal direction. The profiled seal is attached to the glazed element 2 only by the fact that only the base 30 is attached to the inner face 22 and only to this inner face 22. In this way, the base 30 does not face the edge face 21; it is the bead that faces the edge face 21.

When installed, the bead 31 extends from the edge 21, in this case in surface continuity with the outer face 20 of the glazed element (the bead 31 is “flush” with the outer face 20 of the glazed element).

As can be seen in FIG. 2, in the environment of a corner 27, in this case the lower left corner, the corner has four successive radii of curvature, starting from the side edge 24 and going down to the longitudinal edge 23:
R0 for example 234 mm,
R1 for example 81.5 mm,
R2, for example 75 mm, and
R3 for example 224 mm.

In the environment of corner 27, the corner could have one, two, three, or more than four (successive) radius (radii) of curvature.

In the environment of corner 27, base 30 has a number x≥2 of transverse, recessed, material-removing cutouts 4 and has a number y of curved slot(s) 5.

At a cutout 4, there is no profiled seal material 3 at all. At the location of the (or each) slot 5, the profiled seal material 3 is present; this is merely an incision, with no removal of material. At slot 5, the incision cuts through the entire thickness of base 30. In addition, slot 5 is located closer to the edge of said glazed element 2 than the transverse cutouts 4, that is, further away in a centrifugal direction than cutouts 4 and offset from cutouts 4: when a cutout is observed and a more centrifugal direction than this cutout is considered, there is no slot, as a slot at this location risks excessively weakening the structure of profiled seal 3.

x is an even number, preferably 4≤x≤10. Here x=10 for corner 27. y could be equal to x/2, but then there could be a problem with the non-symmetrical reaction of seal 6 to the curvature of the corner. Preferably, y is different from x/2; y can be equal to x/2+1. Preferably y=x/2−1; this is the best configuration for symmetrical adaptation of the profiled seal 3 to the curvature of the corner. x and y are preferably identical for both corners 27, 27′.

The cross-sectional cutouts 4 are all identical. Each cutout 4 has a length L4 of 5.0 mm and a width 14 of 7.0 mm. Cutouts 4 have a length L4 between 50% and 100% of the width 130 of base 30.

The cutouts 4 have a width 14 of between 50% and 80% of the width 130 of the base 30. There is no cutout in bead 31.

The cutouts 4 are positioned in pairs, with the distance between two cutouts in a pair L44 identical for each pair of cutouts and between 100% and 300% of the length L4 of the cutouts. In addition, a distance between two cutouts of two successive pairs L45 is greater than the distance between two cutouts within a pair L44; this distance between two cutouts of two successive pairs L45 is between 200% and 500% of the length L4.

The slots 5 are located in a boss 34 of the base 30, that is, a thickening of the base 30. There is no slot in bead 31.

Here, the slots 5 are all identical. They are parallel to each other and follow each other along the length of the profiled seal when considered flat, before attachment to the glazed element, as shown in FIG. 3. Each slot 5, oriented longitudinally (along the length of the profiled seal) in this FIG. 3, has a length L5 of 20.0 mm. The width of each slot 5, although visible in [FIG. 4] for the purposes of explanation, is not measurable, as this is not a material removal operation but just an incision, each incision being made with a tool that separates the material on either side of the tool without removing any material.

When the profiled seal is attached to the glazed element, it is possible for one (or more) slot(s) 5 to be visible, that is, to appear as a hole when viewed from the inside, particularly when the radius of curvature is equal to or greater than 100 mm.

When the profiled seal is attached to the glazed element, along the entire length of the corner 27, the slot(s) 5 is (are) curved to follow the curvature of the corner.

Each slot 5 is located in a portion of the profiled seal 3 which is situated between two pairs of cutouts 4 (that is, is situated in the location of the distance between two cutouts of two successive pairs L45) and each slot 5 is here centered in this portion between these two successive pairs. Each slot 5 thus has a length L5 of between 75% and 100% of the distance between two cutouts of two successive pairs L45.

Here, the cutouts 4 have a transverse plane of symmetry S to match the curvature of the corner. They are preferably, viewed from the front:
V-shaped, as seen flat in FIG. 5 and adapted to a corner curvature in FIG. 6;
or U-shape, as seen flat in FIG. 7 and adapted to a corner curvature in FIG. 8
or Y, as seen flat in FIG. 9 and adapted to a corner curvature in FIG. 10.

FIGS. 6, 8 and 10 show that the cutouts 4 allow the profiled seal 3 to be deformed to match the curvature of the glazed element.

The V shape is the preferred shape, which causes the least disturbance to the profile of the rest of the profiled seal in the corner (and in particular the least disturbance to the profile of the bead); here there is an angle G between two wings of the V which is between 45° and 90°, preferably here an angle G of 60°.

The cutouts 4 and slot(s) 5 are preferably provided in each corner of the glazing. There may be no cutouts 4 or slots 5 along the longitudinal edges 23, 25, or along the lateral edges 24, 26.

To manufacture the glazing unit according to the invention, it is possible to first manufacture, that is, prefabricate, the profiled seal with, in the said base 30, the number x≥2, of cutouts 4 and the number y of slot(s) 5, per corner, then to attach, for example by gluing, the profiled seal 3 to the said glazed element 2, that is, to attach the base 30 to the inner face 22 with the cutouts and the slot(s) located in the environment of the corner 27; the slot(s) 5 are located closer to the edge of the glazed element 2 than the cutouts 4.

When the profiled seal 3 is prefabricated, the base 30 of the profiled seal 3 is preferably attached to the inner face 22, and preferably only to this inner face (not to the edge face or outer face), for example using double-sided adhesive tape 32 or a bead of glue.

In another variant, to manufacture the glazing according to the invention, it is possible to mold the profiled seal directly onto the glazed element 2 with, in said base 30, the number x≥2, of cutouts 4 and the number y of slot(s) 5, per corner, the profiled seal 3 then being attached to the glazed element 2 (or “encapsulated”), that is, the base 30 being attached to the inner face 22 with the cutouts and slot(s) located in the vicinity of the corner 27; the slot(s) 5 are located closer to the edge of the glazed element 2 than the cutouts 4.

Thanks to the invention, along the entire length of corner 27, bead 31 retains its profile and can extend from edge face 21 in surface continuity with the outer face 20 of the glazed element (bead 31 is “flush” with the outer face 20 of the glazed element).

1. A glazing unit comprising a glazed element and a profiled seal, said glazed element having an outer face, an inner face and an edge face located between the outer and inner faces, a longitudinal edge, a lateral edge and a rounded corner having at least one radius of curvature and being located between said longitudinal edge and said lateral edge, said profiled seal having a base and a lateral bead, said base being attached to said inner face and said bead extending from said base further than said base, wherein in the environment of said corner, said base has a number x≥2 of transverse, recessed, material-removing cutouts, and has a number y of one or more curved slot passing through a thickness of said base and located closer to the edge of said glazed element than said cutouts.

2. The glazing unit according to claim 1, wherein x is an even number and y=x/2+1, or y=x/2−1.

3. The glazing unit according to claim 1, wherein at least one, cutout has a transverse plane of symmetry.

4. The glazing unit according to claim 1, wherein said radius of curvature, or each radius of curvature, is between 50 mm and 230 mm.

5. The glazing unit according to claim 1, wherein at least one cutout has a width of between 50% and 80% of the width of said base.

6. The glazing unit according to claim 1, wherein said one or more slots are located in a boss of said base.

7. The glazing unit according to claim 1, wherein at least one cutout has a length and said cutouts are positioned in pairs, with a distance between two cutouts of a pair of between 100% and 300% of said length and with a distance between two cutouts of two successive pairs which is greater than said distance between two cutouts of a pair and which is between 200% and 500% of said length.

8. The glazing unit according to claim 1, wherein at least one cutout has a length of between 50% and 100% of the width of said base.

9. The glazing unit according to claim 7, wherein said one or more slots are located in a portion of said profiled seal which is located between two pairs of cutouts and said one or more slots have a length of between 75% and 100% of said distance between two pairs.

10. A profiled seal for the glazing unit according to claim 1, said profiled seal having a base and a lateral bead, said base being intended to be attached to said inner face of said glazed element and said bead extending from said base further than said base, wherein said base has a number x≥2 of transverse, recessed, material-removing cutouts and has a number y of one or more slots passing through the thickness of said base and intended to be located closer to the edge of said glazed element than said cutouts.

11. A method of manufacturing a glazing unit according to claim 1, comprising a glazed element and a profiled seal, said glazed element having an outer face, an inner face and an edge face located between these two faces, a longitudinal edge, a lateral edge and a rounded corner, having at least one radius of curvature and being located between said longitudinal edge and said lateral edge, said profiled seal having a base and a lateral bead, said base being attached to said inner face and said bead extending from said base further than said base, wherein
a number x≥2, of transverse, recessed cutouts are made in said base with removal of material and a number y of one or more slots, are made in said base through a thickness of said base, then
said profiled seal is attached to said glazed element with the cutouts and the one or more slots located in the environment of said corner, with said one or more slots located closer to the edge of said glazed element than said cutouts and with said one or more slots curved into the environment of said corner.

12. The glazing unit according to claim 2, wherein 4≤x≤10.

13. The glazing unit according to claim 3, wherein each cutout has a transverse plane of symmetry.

14. The glazing unit according to claim 3, wherein the at least one cutout is, viewed from the front, V-, U- or Y-shaped.

15. The glazing unit according to claim 14, wherein the at least one cutout is V-shaped with an angle between two wings of the V of between 45° and 90°.

16. The glazing unit according to claim 15, wherein the angle is approximately 60°.

17. The glazing unit according to claim 5, wherein each cutout has a width of between 50% and 80% of the width of said base.

18. The glazing unit according to claim 7, wherein each cutout has a length and said cutouts are positioned in pairs, with a distance between two cutouts of a pair of between 100% and 300% of said length and with a distance between two cutouts of two successive pairs which is greater than said distance between two cutouts of a pair and which is between 200% and 500% of said length.

19. The glazing unit according to claim 8, wherein each cutout has a length of between 50% and 100% of the width of said base.
